(19) United States
(12) Patent Application Publication
(10) Pub. No.: US 2021/0027155 A1
(43) Pub. Date: Jan. 28, 2021

(54) CUSTOMIZED MODELS FOR ON-DEVICE PROCESSING WORKFLOWS

(71) Applicant: VMware, Inc., Palo Alto, CA (US)

(72) Inventors: Ravish Chawla, Marietta, GA (US); Kar-Fai Tse, Peachtree Corners, GA (US); Chaoting Xuan, Duluth, GA (US)

(21) Appl. No.: 16/519,338

(22) Filed: Jul. 23, 2019

(51) Int. Cl. G06N 3/08; G06F 17/21; G06F 9/38; G06Q 10/10

(52) U.S. Cl. CPC G06N 3/08; G06Q 10/103; G06F 9/3877; G06F 17/21

(57) ABSTRACT

Examples described herein include systems and methods for implementing customized, on-device processing workflows. An example method can include training different natural language processing (“NLP”) models using distinct datasets relevant to different backend systems. The different NLP models can be assigned to user devices based on each device user's organizational group. The user devices can implement the customized NLP models to detect triggers within text of an application. Based on the detected trigger, the application can display a user interface element having a selectable actionable button for carrying out an action with respect to the backend system. In some examples, the detected trigger can automatically cause an action to be carried out with respect to the backend system.

### BACKGROUND

Many applications perform operations on text documents. For example, an email application can perform searches or other text-based processing on emails. But current implementations of text-based processing have many drawbacks that, if overcome, could improve processing techniques and utilization.

Natural Language Processing (“NLP”) techniques can provide textual analysis and detection of triggering words or phrases. These triggers can be used to launch context-specific workflows for users. However, NLP techniques typically require large datasets and substantial computing resources. As a result, NLP algorithms are generally trained and operated in the cloud, using substantial computing resources that may be spread across many computing devices. For users or organizations that require a high level of privacy, sending emails to a remote cloud location for textual analysis may present privacy concerns or violate relevant privacy policies.

As a result, a need exists for on-device NLP models that require a smaller footprint and maintain private information on a user's device. A further need exists for tailoring these models to provide users with models that are customized to their needs. This can further reduce the resources required by the model on the device, as well as increase productivity by ensuring that the results obtained from the model are relevant to the user's needs. Finally, an additional need exists for improving workflows that implement NLP models.

### SUMMARY

Examples described herein include systems and methods for implementing customized, on-device processing workflows. An example method can include training a first NLP model using a first dataset relevant to a first backend system. The backend system can be any external system utilized by a user or an enterprise. Example backend systems include, but are not limited to, CONCUR, JIRA, and SALESFORCE. The NLP model can be trained using words and phrases relevant to at least one backend system.

The example method can also include training a second NLP model, distinct from the first model, using a second dataset relevant to a second backend system. The second backend system can be different from the first backend system. In some examples, the models are trained based on datasets relevant to multiple backend systems with at least one backend system differing for each model. The models can be trained at a location remote to the user devices on which they will be implemented, such as at a management server.

The example method can further include assigning the first and second NLP models to respective organizational groups. An organizational group can be a group of users, for example within an enterprise, that can be defined by an administrative user. For example, an enterprise can establish a “legal” organizational group that includes members of the legal department, a “sales” organizational group that includes members of the sales department, and so on. An administrative user can access the management server that stores organizational-group information for the organization, along with user information and device information. The administrative user can assign the customized models to specific organizational groups through the console.

The management server can determine that a first user device is assigned to a user belonging to the first organizational group. Based on this determination, the management server can provide the first NLP model to the first user device, either directly or by instructing the user device to retrieve the model from a storage location. The management server can also instruct the first user device to implement the first NLP model with at least application installed on the user device. Implementing the model can include detecting a first trigger within text of the application and displaying a user interface element on the user device based on the detected trigger. The user interface element can be a card element in one example.

The example method can also include, based on determining that a second user device is assigned to a second user belonging to a second organizational group, providing a second NLP model to that user device. The method can include instructing the second user device to implement the second NLP model with an application on the second user device. As with the first model, implementing the second NLP model can include detecting a trigger within text of the application and displaying a user interface element on the second user device based on the detected trigger.

The user interface element displayed on the user device can include an actionable item that, if selected by the user, causes the backend system to perform an action. The action can include, for example, authorizing a request, booking a trip, or marking an event completed. In some examples, implementing the NLP model includes automatically performing an action at the backend system without requiring the selection of an actionable item by the user. In some examples, implementation can also include reporting actions to the user or to the management server. The model can provide feedback to the management server in order to improve future iterations of the model as well.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of a system for implementing customized, on-device processing workflows.

FIG. 2 is a flowchart of an example method for implementing customized, on-device processing workflows.

FIG. 3 is a sequence diagram of an example method for implementing customized, on-device processing workflows.

FIG. 4 is a sequence diagram of an example method for implementing customized, on-device processing workflows for automatically performing actions.

FIG. 5 is an illustration of an example graphical user interface (“GUI”) of a user device used to perform various methods described herein.

FIG. 6 is an illustration of a second example GUI of a user device used to perform various methods described herein.

FIG. 7 is an illustration of a third example GUI of a user device used to perform various methods described herein.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Examples described herein include systems and methods for implementing customized, on-device processing workflows. An example method can include training a first NLP model using a first dataset relevant to a first backend system. The method can also include training a second NLP model, distinct from the first model, using a second dataset relevant to a second backend system that is distinct from the first backend system. The models can be trained at a location remote to the user devices on which they will be implemented, such as at a management server.

The example method can further include assigning the first and second NLP models to respective organizational groups. The management server can determine that a first user device is assigned to a user belonging to the first organizational group. Based on this determination, the management server can provide the first NLP model to the first user device, either directly or by instructing the user device to retrieve the model from a storage location. The management server can also instruct the first user device to implement the first NLP model with at least application installed on the user device. Implementing the model can include detecting a first trigger within text of the application and displaying a user interface element on the user device based on the detected trigger. The management server can similarly provide the second model to a second user device associated with a second organizational group.

The user interface element displayed on the user device can include an actionable item that, if selected by the user, causes the backend system to perform an action. The action can include, for example, authorizing a request, booking a trip, or marking an event completed. In some examples, implementing the NLP model includes automatically performing an action at the backend system without requiring the selection of an actionable item by the user. In some examples, implementation can also include reporting actions to the user or to the management server. The model can provide feedback to the management server in order to improve future iterations of the model as well.

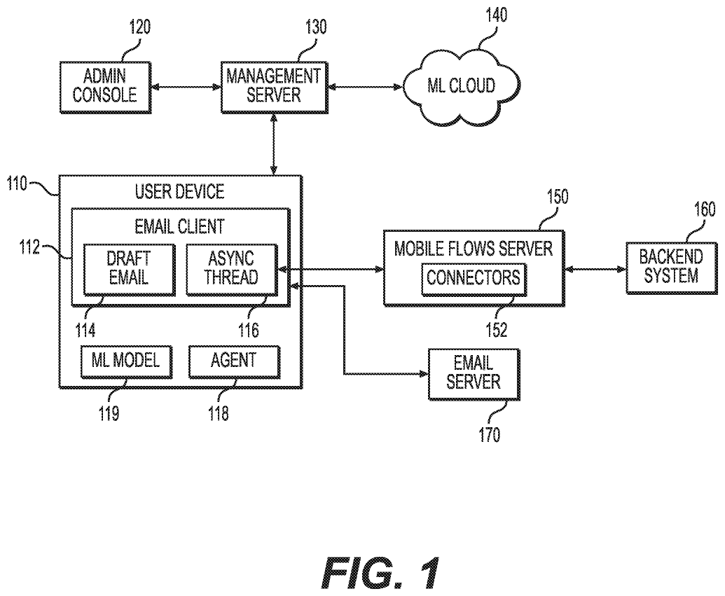

FIG. 1 provides an illustration of a system for implementing customized, on-device processing workflows. The system can include a user device 110, which can be any type of computing device. Common examples of a user device 110 include laptop and desktop computers, phones, smartphones, and tablets. The user device 110 can include a processor, which can be a hardware processor such as a single- or multi-core central processing unit (“CPU”). The processor can execute instructions stored in a non-transitory, computer-readable storage medium. For example, the instructions can be stored in a memory storage location of the user device 110.

The user device 110 can include various applications such as applications provided by default with the operating system of the user device 110, applications downloaded from an application store, applications provisioned by a server or other component of a management system, and web-based applications. In this example, the user device 110 includes an email application 112 to be discussed further, below.

The system can also include a management server 130. The management server 130 can be a single server or a group of servers having at least one processor. The management server 130 can include a storage location accessible to the server, either locally or remotely. The management server 130 can provide various management functions for a user device 110. For example, the management server 130 can handle an enrollment procedure that enrolls a user device 110 into the overall management system. An enrollment procedure can be instigated by contacting the management server 130 at a specific URL that triggers enrollment. The management server 130 can also provision applications and profiles to the user device 110. The profiles can be used to remotely control certain functionality of the user device 110, such as access to enterprise resources.

An administrative user can access settings controlled by the management server 130 through an administrator console 120. The console 120 can be accessed through a browser application and displayed as a web page, for example. In other examples, the console 120 can be a dedicated kiosk-type device. An administrator can configure settings through the console 120, such as by creating a profile for a user. The management server 130 can receive the configurations through the console 120 and take necessary actions, such as generating the profile and causing it to be transmitted to the user device 110.

An administrative user can define organizational groups that include multiple users. The administrative user can also add or remove users from those groups as required. An organizational group can be assigned based upon any type of categorization, or even randomly. For example, an accounting organizational group can be created for all users in the accounting department, while a legal organizational group can be created for all users in the legal department. In another example, an Atlanta group can be created for all users located in Atlanta, rather than another office location. In yet another example, a second-floor organizational group can be created for all users on the second floor of an office building. The administrative user can define these organizational groups as desired. In some examples, when a user belongs to an organizational group, any enrolled devices 110 of that user also belong to the same organizational group.

The management server 130 can communicate with a machine learning (“ML”) cloud 140. The ML cloud 140 can be an ML platform provided by a third party, in an example. The ML cloud 140 can provide one or more machine-learning models to the management server 130 or to a user device 110. The cloud 140 can also maintain the models in the cloud 140 and run the models using input provided from the management server 130 or other device. The ML cloud 140 can also receive feedback regarding an ML model 119 and use that feedback to adapt the model over time. The ML cloud 140 can be located remote from the management server 130, but the management server 130 can communicate over the network with the ML cloud 140 to request delivery of a model, providing a dataset for training a model, provide inputs to run through a trained model, or provide feedback to further adapt a trained model. In some examples, the user device 110 can also communicate with the ML cloud 140 for some, or all, of the same purposes identified above with respect to the management server 130.

The user device 110 can include a management agent 118 that allows the management server 130 to exercise some measure of control over the user device 110. The agent 118 can be installed by the management server 130 as part of an enrollment process that enrolls the user device 110 with the management system. The agent 118 can be a standalone application, or it can be wrapped into another application, such as a portal application that provides access to various enterprise applications. The agent 118 need not operate on the application layer, however, and can instead be implemented at the operating-system level in some examples.

The agent 118 can control functionality of the device 110, such as by allowing or disallowing various hardware or software features. The agent 118 can control these features based on profiles provided by the management server 130. For example, a profile can implement a compliance rule that requires the latest version of an operation system to be installed on a device 110 before allowing the device 110 to access an enterprise application. The agent 118 can carry out the compliance rule by checking the version of the operating system on the device 110 and blocking or allowing access to the enterprise application accordingly.

The user device 110 can also include an email client 112, which can be any type of email application. Although the functionality described herein relates to an email client 112, the same disclosure can apply to any type of application capable of operating on text documents. Examples include messaging applications such as SLACK and word-processing applications such as WORD. References to the email client 112 or to an “email” are not intended to be limiting, and instead are intended to capture any type of application that can operate on text-based messages or documents.

The email client 112 can send and receive emails by utilizing an email server 170. The email server 170 can be a remote server that stores information about a user's email account, such as the emails currently in the user's inbox, and provides that information to the user device 110. The email server 170 can also send outgoing emails on behalf of the user device 110, to be received by a separate server or device on the other end of the communication chain. In some examples, the email server 170 also includes a gateway having privileged access to the email server 170, either incorporated into the email server 170 or provided as a standalone gateway server. The gateway can communicate with the management server 130 and implement rules for allowing or disallowing access to the email server 170.

In addition to storing emails in a user's inbox, the email client 112 can also include a draft email 114 that a user has generated. The methods described herein can be applied to a draft email 114 as well as an email in an inbox or other folder of the email client 112. As used herein, the term “email” includes emails received or sent by the email client 112 as well as draft emails 114. The email client 112 can also include an asynchronous thread 116. The asynchronous thread 116 can be a programmed unit of work that runs separately from the primary thread executing the email client 112. The asynchronous thread 116 can therefore take actions behind the scenes without waiting for responses or acknowledgements from the primary thread executing the email client 112 itself

For example, the asynchronous thread 116 can implement ML models 119 to perform NLP techniques on an email. One such NLP technique is natural language understanding (“NLU”). NLU describes a process where machine learning is used to classify intents and extract entities from slots. For instance, given a natural language phrase like “What is the weather in Atlanta?” the NLU process should determine the intent as a “weather_query” and the location slot as “Atlanta.” NLU can be used in chatbots and virtual assistants, where the inputs are usually short phrases, or “utterances,” provided by a human in real-time. However, the systems and methods described herein apply NLU—or more generally, NLP—to large-document formats. The terms ML, NLP, and NLU (and respective models thereof) are used broadly and interchangeably herein.

The ML models 119 can also utilize “embeddings,” which can be used to map words into numerical vectors and also cluster vectors having similar meanings or semantics. For example, the embedding vector of the word “king” should be very close to the vector of the word “emperor.” Natural language utterances can be used as inputs to the embedding layer. Pre-trained embeddings can allow a ML model 119 to learn meaningful relationships between words and labels, even on a sparse dataset.

The asynchronous thread 116 can apply one or more ML models 119 that are stored on the user device 110. The ML models 119 can be provided to the user device 110 by the management server 130, or in some examples, directly from the ML cloud 140. The ML models 119 can be used to process the text of a document, such as an email, and identify intents and associated slots within the relevant text. The ML models 119 can be trained with a dataset specific to a user or group of users. For example, an ML model 119 can be trained with a dataset relevant to users in the accounting organizational group. The management server 130 can then provide the accounting-group-specific ML model 119 to user devices 110 assigned to users in the accounting organizational group. This can allow the ML model 119 to provide relevant, useful results for the user, even based upon a small training dataset.

The asynchronous thread 116 can utilize an operation-system-based framework provided on the user device 110, if available. An example of such a framework is CoreML, available on APPLE devices running iOS. The framework allows developers to run deep learning neural networks on a device's 110 graphical processing unit (“GPU”). An ML model 119 can be converted into a device-ready executable file, allowing the device 110 to process text using only the ML model 119 residing on the device 110.

The asynchronous thread 116 can apply an ML model 119 to a text document, such as a draft email 114, and determine any relevant “intents” and associated “slots” for the text. An intent can be any type of action, such as changing a password, deleting an account, and requesting a recommendation. The identified slots can provide further context to the intent, such as an account name, type of software, time, or a location. In some examples, the asynchronous thread 116 can also apply tags, or labels, to the words within an intent. An intent can be a chunk of multiple words, so each word can be labeled accordingly. In some examples, the Inside-Out-Beginning (“IOB”) format can be used. In this format, each word in an intent is labeled with an O-tag, B-tag, or I-tag, based on where the words appear. For example, the first word in an intent can be labeled with a B-tag, the following word can be labeled with an I-tag, and words that are not part of a slot can be given an O-tag. IOB tags can distinguish different types of words from each other, allowing the ML model 119 to learn semantic relationships between them and the words that relate to their context.

The asynchronous thread 116 can pass the output from the ML model 119 to a mobile flows server 150. The mobile flows server 150 can be a standalone server or a group of servers. The mobile flows server 150 can utilize one or more connectors 152 that provide access to a backend system 160, such as a third-party service. Different backend systems 160 can correlate to different connectors 152, in an example, and a backend system 160 can include one or more servers. A connector 152 can be executable code that accesses information stored by, or relating to, a backend system 160. For example, a connector 152 can utilize a third-party specific API to retrieve information from a third-party system 160. A connector 152 can utilize APIs to connect to internal backend systems 160 as well as external, third-party backend systems. The connector 152 can request a specific action based on input received from the user device 110. The various types of responses and actions available from the mobile flows server 150 are discussed in more detail, below.

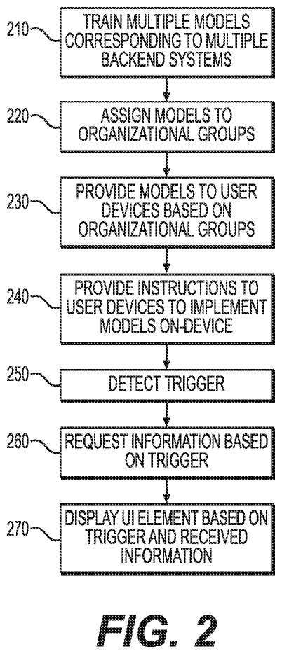

FIG. 2 provides a flowchart of an example method for implementing customized, on-device processing workflows, which can be implemented in the system of FIG. 1. Stage 210 can include training multiple ML models 119 corresponding to multiple backend systems 160. As explained earlier, the ML models 119 can be NLP models or NLU models. A first ML model 119 can be trained for a first backend system using a dataset relevant to that backend system. For example, the first backend system can be an expense management system like CONCUR. The dataset used to train this backend system can include terms such as invoice, expense, travel, book, cost, flight, hotel, and approve.

Similarly, a second ML model 119 can be trained for a second backend system using a dataset relevant to the second system. For example, the second backend system can be a customer-relationship-management program such as SALESFORCE. The dataset used to train this backend system can include terms such as client, sale, support, customer, order, fulfillment, and shipping. The ML models 119 can be trained at the ML cloud 140 in an example. In some examples, the training can be performed based on a request from the management server 130. For example, an administrator can provide keywords through the console 120 that are then forwarded to the ML cloud 140 by the management server 130. Although the training described above

The ML models 119 can be assigned to particular organizational groups at stage 220 of the example method. This stage can be performed by an administrative user through the administrative console 120, for example. The administrative user can identify one or more ML models 119 and select an option to apply the selected models 119 to one or more organizational groups. Multiple models 119 can be applied to an organizational group. Similarly, each model 119 can be applied to multiple organizational groups. The management server 130 can receive the assignment determination from the console 120 and store data reflecting those assignments as part of stage 220.

At stage 230, the management server 130 can provide the ML models 119 to user devices 110 based on the organizational groups to which those devices belong. For example, if a user is a member of the Sales organizational group and has two enrolled user devices 110, the management server 130 can provide a Sales-related ML model 119 to the user's two devices 110. The management server 130 can provide the models 119 by sending them directly or by instructing a user device 110 to download the models 119 from another location, such as a dedicated download server or the ML cloud 140.

At stage 240, the management server 130 can provide instructions to user devices 110 regarding implementing the ML models 119. This stage can occur at any time, even before the models 119 are provided to a user device 110. In some examples, the instructions can be provided to the user device through code within an application. For example, an email application 112 can be updated to incorporate new software code that provides instructions for implementing ML models 119. In another example, an executable file can be sent to the user device 110 with appropriate instructions. The instructions can detail how and when a user device 110 should utilize an ML model 119, such as by running the text of each incoming email through the model 119.

At stage 250, the user device 110 can detect a trigger based on the processing performed using the ML model 119. In some examples, the detection of an “intent” is the trigger. The intent can relate to the email client 112 itself, the mobile flows server 150, or any backend system 160 available to the user. For example, the ML model 119 can determine that an incoming email includes an intent relating to authorizing an expense. The determination that the text portion of the email includes an intent, such as authorization, can constitute a trigger at stage 250. The trigger can also include the “slot” related to the intent. For example, if the intent is authorization, the slot can be an expense report.

After recognizing the triggering intent and a related slot, at stage 260 the user device 110 can request information from the mobile flows server 150 based on the intent-slot pairing. The request can identify the pairing by providing an object, such as a JSON or XML file, that includes the intent and slot detected by the ML model 119. The mobile flows server 150 can receive the object, identify a relevant backend system 160, and then use an appropriate connector 152 to access the backend system 160. The mobile flows server 150 can also contact the management server 130 or other systems in order to gather useful information for the user.

The mobile flows server 150 can provide information back to the user device 110 at stage 270, causing the device 110 to display a user interface element based on the intent-slot pairing and the additional information provided by the mobile flows server 150. The user interface element can include actionable buttons that a user can select to perform an action related to the intent-slot pairing. For example, if the intent was authorization and the slot was a particular expenditure, the user interface element can provide information about the expenditure as well as actionable elements for authorizing or declining the expenditure. The user's input can then be relayed back to the mobile flows server 150, which in turn can utilize a connector 152 to access the relevant backend system 160 and make any change indicated by the user's input.

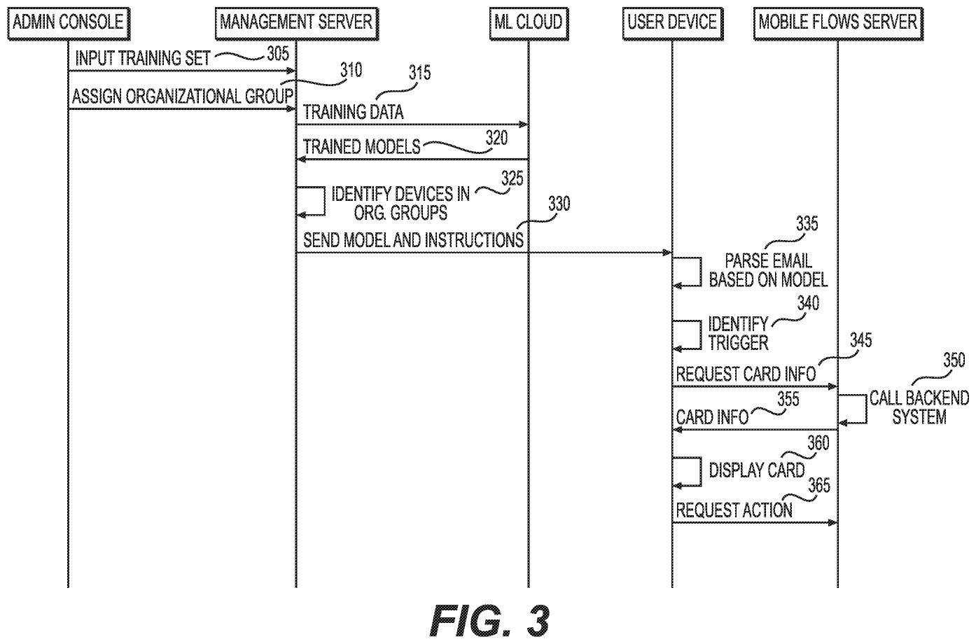

FIG. 3 provides a sequence diagram of an example method for implementing customized, on-device processing workflows. At stage 305, an administrative user can provide a dataset for training a ML model 119. The dataset can include words and phrases that are relevant to at least one backend system. The administrative user can provide the dataset through an administrator console 120, for example. Using the console 120, at stage 310 the administrative user can also assign one or more organizational groups to the model 119 that will be trained using the dataset provided at stage 305. In some examples, the administrative user can configure the model 119 and assign it to an organizational group from the same console page. The console 120 can communicate these inputs to the management server 130.

At stage 315, the management server 130 can provide the training dataset to the ML cloud 140. In some examples, the management server 130 also identifies a basic ML model 119 at this stage, to be trained at the ML cloud 140 using the provided dataset. In other examples, the ML cloud 140 can select a suitable model 119 without further input from the management server 130. The ML cloud 140 can train the model 119 and return it to the management server at stage 320. In some examples, the ML cloud 140 stores the trained model 119 within the ML cloud 140 or at another storage location accessible to it or the management server 130.

At stage 325, the management server 130 can identify user devices that belong to a particular organizational group. This can be performed based on an instruction to provide a particular ML model 119 to one or more organizational groups. The management server 130 can first determine a list of users in the organizational group and then identify associated user devices 110 for the users on that list. The management server 130 can then send the ML model 119 to relevant user devices 110 at stage 330, based on the assignments provided at stage 310. The management server 130 can also provide instructions to the user devices 110 at this stage, instructing the user devices 110 to implement relevant ML models 119 and take further workflow steps as described herein.

At stage 335, the user device 110 can parse an email and run the text of the email through one or more ML models 119 provided in earlier stages. The email can be a draft email, a sent email, or a received email, in some examples. As explained earlier, although the term “email” is used herein, any text message or document can apply. The text of the email or other document can be parsed at stage 335. Based on the output from the ML model 119, at stage 340 the user device 110 can identify a trigger. The trigger can be an “intent” and, in some examples, an associated “slot” for the intent.

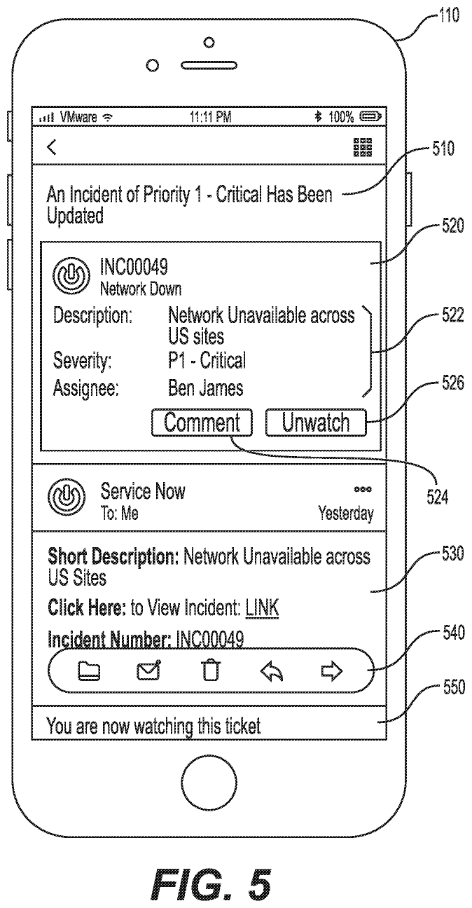

At stage 345, the user device 110 can request information from the mobile flows server 150. The request can be a card request that requests information sufficient for the user device 110 to display a user interface element to the user. Example user interface elements are shown and discussed with respect to FIGS. 5-7. The user interface elements can be in the form of a card element in some examples. The request can include an object, such as a JSON or XML file, having at least an intent-slot pairing determined at stage 340. The mobile flows server 150 can identify an appropriate connector 152 at stage 350, based the request at stage 345 implicating a particular backend system. The mobile flows server 150 can then call the backend system as part of stage 350, such as by using an application programming interface (“API”) call. The call can request relevant information to be included in a user interface element. The mobile flows server 150 can provide this card information to the user device 110 at stage 355.

At stage 360, the user device 110 can generate and display a user interface element. The user interface element can be displayed within the email application 112 itself, allowing a user to interact with the element without navigating away from the application 112. For example, the user interface element can be displayed above, below, or on top of the email that prompted the card to be displayed. The card can include one or more actionable buttons that, if selected, cause further action to be taken. In the example of authorizing an expenditure, the user interface element can display an amount and description of the expenditure along with actionable buttons for approving or declining the expenditure.

Based on the user's input with respect to the actionable buttons, at stage 365 the user device 110 can request an action from the mobile flows server 150. For example, if the user selects an actionable button to approve an expenditure, then at stage 365 the user device 110 can inform the mobile flows server 150 of this selection. The mobile flows server 150 can then utilize an appropriate connector 152 to contact the relevant backend system 160 and provide an instruction to carry out the action indicated by the user.

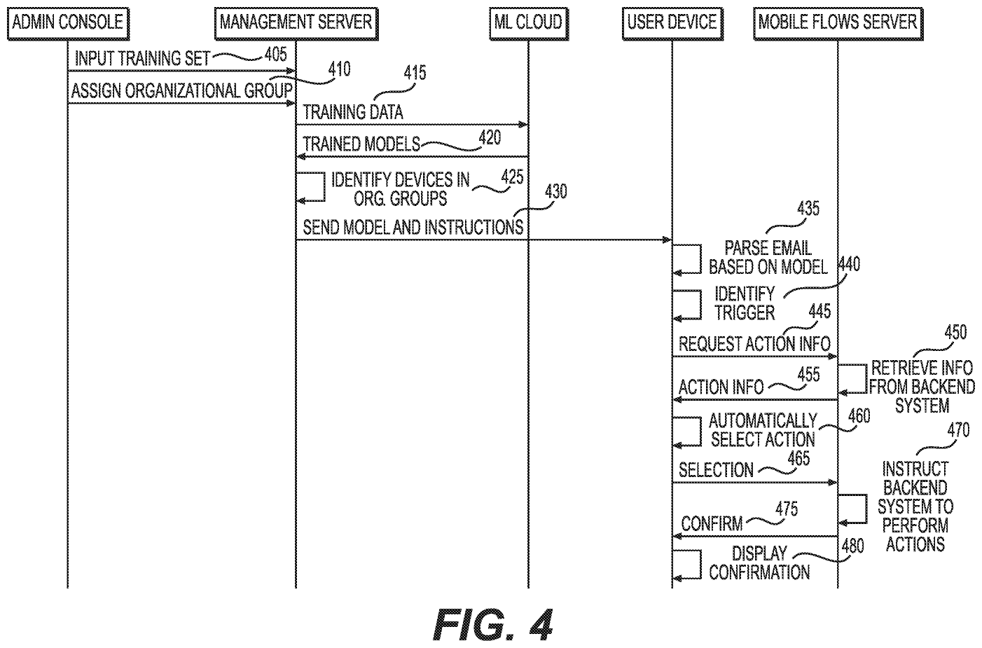

FIG. 4 provides a sequence diagram of an example method for implementing customized, on-device processing workflows. The example of FIG. 4 is similar to that of FIG. 3, but the method of FIG. 4 includes some automated steps described below. Stages 405-440 of FIG. 4 correspond to stages 305-340 described above, and therefore are not repeated here.

At stage 445, the user device 110 can request action information from the mobile flows server 150. The request at this stage can be the same as the request described with respect to stage 345 of FIG. 3, in some examples. In one example, the request for action information includes a request for information sufficient to determine available actions based on the intent-slot pairing identified at stage 440. The request therefore need not include a request for the graphical components of a card at this stage, although in some examples that can be included in the request as well.

At stage 450, the mobile flows server 150 can identify a relevant backend system and a corresponding connector 152. Using that connector 152, the mobile flows server 150 can retrieve information from the backend system, such as information relating to actions that can be taken at the backend system with respect to the identified intent-slot pairing. For example, the mobile flows server 150 can provide an intent-slot pairing that includes, an intent to book a flight, and a slot describing a day or time at which the flight should be booked. The mobile flows server 150 can then reach out to a backend system 160 such as CONCUR to retrieve any available actions for booking a flight on a particular day. The backend system 160 can respond with, for example, several available flight options and associated costs. This information can be passed to the user device 110 at stage 455.

At stage 460, the user device 110 can automatically select from the available actions provided by the mobile flows server 150. These actions can include, for example, declining the request, taking no automatic action and instead prompting the user to take the action, or automatically selecting from an available option. In the example from the previous paragraph, the user device 110 could parse the flight options provided by the mobile flows server 150 and select one using a relevant algorithm. For example, the user device 110 could select the cheapest flight option provided by the backend system. In another example, the user device 110 could select the earliest flight option. In a different example relating to authorizing an expenditure, the user device 110 could automatically authorize or decline the expenditure.

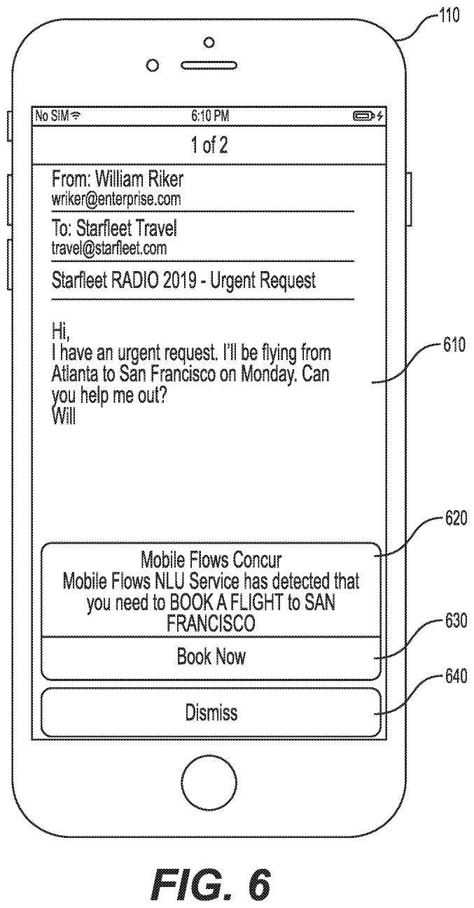

In some examples, rather than automatically selecting an action at stage 460, the user device 110 can present the user with a selection at stage 465. For example, the device 110 can predict an action that the user likely wishes to perform. The device 110 can then display a graphical element asking if the user wants to perform the predicted task. In some examples, the device 110 can utilize an OS-based notification system to present the message and option to confirm or dismiss. This example is described in more detail with respect to FIG. 6.

Regardless of whether the selection is automatic or manual, the user device 110 can communicate the selection back to the mobile flows server 150 at stage 465. After making or receiving a selection, the mobile flows server 150 can instruct the backend system to perform one or more actions at stage 470. This stage can include, for example, instructing the backend system 160 to book a particular flight for the user or to authorize or decline an expenditure.

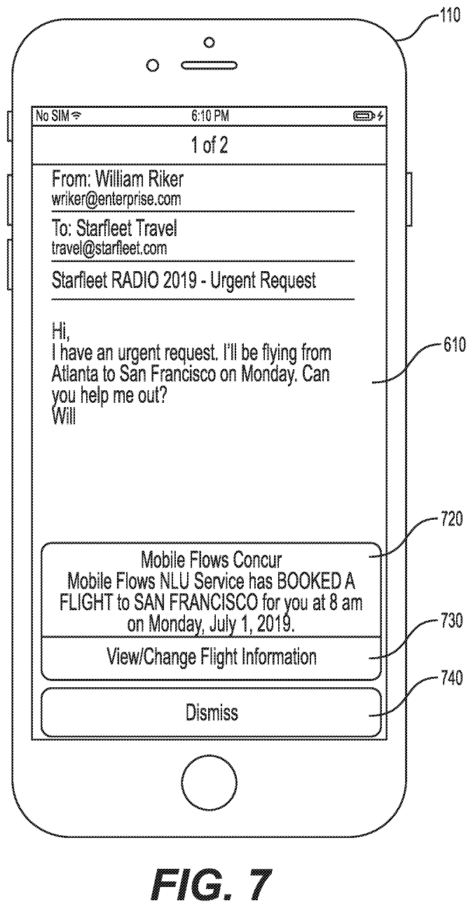

The mobile flows server 150 can provide confirmation information to the user device 110 at stage 475, which in turn can display confirmation on the user device 110 display. The confirmation can explain to the user that an automated action was taken and provide the user with an opportunity to change that selection after the fact. An example display along these lines is shown in FIG. 7 and described in more detail below.

FIG. 5 provides an illustration of an example GUI of a user device used to perform various methods described herein. FIG. 5 depicts a user device 110 displaying an email application. The email application has received and is displaying an email 530 regarding a backend system relating to IT service management. The GUI is also displaying a user interface element 520 that has been generated using a method such as the method described with respect to FIG. 3. The card 520 includes an information section 522 providing relevant information from the backend system 160.

The card 520 also includes two action buttons 524, 526. In this example, the first action button 524 allows a user to comment on a ticket while a second action button 526 allows the user to watch or unwatch the ticket. In this example, the user has already selected the second action button 526, indicating that the user wants to watch the ticket. The GUI therefore includes a message 550 alerting the user that he or she is now watching the ticket. Although two action buttons 524, 526 are shown, any number of action buttons may be provided on the card 520. Similarly, although this card relates to an IT-service-management backend system, the card can relate to any type of backend system.

Additionally, the GUI of FIG. 5 also includes a title section 510 that summarizes the email, card, or both. The GUI also includes a toolbar 540 for performing email operations within the email client 112.

FIG. 6 provides another GUI view of the user device 110 implementing an example method. The GUI is displaying an email 610 that includes an “urgent request” from someone “flying from Atlanta to San Francisco on Monday.” In this example, the user device 110 has utilized its on-device ML model 119—in conjunction with the mobile flows server 150—to determine that the CONCUR backend system 160 should be leveraged to book a flight to San Francisco from the user's current location of Atlanta. The device 110 has therefore displayed an OS-based notification 620 regarding the flight. Accompanying the notification 620 is a graphical “Book Now” button 630 that can launch the user into a relevant CONCUR session for booking the flight. The user can also select a dismiss button 640 to dismiss the notification 620.

FIG. 7 provides an example GUI view of the user device 110 while viewing the same email 610 as FIG. 6. As in the previous example, the user device 110 has detected that the user needs to book a flight from Atlanta to San Francisco on Monday. But in this example, the system has automatically booked the flight already. The user device 110 then displayed an OS-based notification 720 describing that a flight has been booked for a particular day and time. The notification 720 includes a graphical element 730 for viewing or changing the flight information. That element 730 can launch a relevant CONCUR page in this example. The GUI also includes a dismiss button 740 for dismissing the notification 720.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for implementing customized, on-device processing workflows, comprising:
training a first natural language processing (NLP) model using a first dataset relevant to a first backend system;
training a second NLP model using a second dataset relevant to a second backend system distinct from the first backend system;
assigning the first NLP model to a first organizational group comprising a first plurality of users;
assigning the second NLP model to a second organizational group comprising a second plurality of users;
based on determining that a first user device is assigned to a first user of the first plurality of users in the first organizational group:
providing the first NLP model to the first user device; and
instructing the first user device to implement the first NLP model with at least one application installed on the first user device, wherein implementing the first NLP model comprises:
detecting, at the first user device, a first trigger within text of the at least one application; and
displaying a first user interface element on the first user device based on the detected first trigger.

2. The method of claim 1, further comprising, based on determining that a second user device is assigned to a second user of the second plurality of users in the second organizational group:
providing the second NLP model to the second user device; and
instructing the second user device to implement the second NLP model with at least one application installed on the second user device, wherein implementing the second NLP model comprises:
detecting a second trigger within text of the at least one application; and
displaying a second user interface element on the second user device based on the detected second trigger.

3. The method of claim 1, wherein the first user interface element is a card element comprising an actionable item that, if selected by the first user, causes the first backend system to perform an action.

4. The method of claim 1, wherein implementing the first NLP model further comprises automatically performing an action at the first backend system based on a determination by the first NLP model.

5. The method of claim 4, wherein automatically performing an action at the first backend system comprises at least one of: ordering an item, authorizing an expenditure, and approving a request.

6. The method of claim 1, wherein training the first and send NLP models is performed at a management server remote from the first and second user devices.

7. The method of claim 1, wherein implementing the first NLP model further comprises reporting results of the first NLP model to a management server.

8. A non-transitory, computer-readable medium containing instructions that, when executed by a hardware-based processor, performs stages for implementing customized, on-device processing workflows, the stages comprising:
training a first natural language processing (NLP) model using a first dataset relevant to a first backend system;
training a second NLP model using a second dataset relevant to a second backend system distinct from the first backend system;
assigning the first NLP model to a first organizational group comprising a first plurality of users;
assigning the second NLP model to a second organizational group comprising a second plurality of users;
based on determining that a first user device is assigned to a first user of the first plurality of users in the first organizational group:
providing the first NLP model to the first user device; and
instructing the first user device to implement the first NLP model with at least one application installed on the first user device, wherein implementing the first NLP model comprises:
detecting, at the first user device, a first trigger within text of the at least one application; and
displaying a first user interface element on the first user device based on the detected first trigger.

9. The non-transitory, computer-readable medium of claim 8, the stages further comprising, based on determining that a second user device is assigned to a second user of the second plurality of users in the second organizational group:
providing the second NLP model to the second user device; and
instructing the second user device to implement the second NLP model with at least one application installed on the second user device, wherein implementing the second NLP model comprises:
detecting a second trigger within text of the at least one application; and
displaying a second user interface element on the second user device based on the detected second trigger.

10. The non-transitory, computer-readable medium of claim 8, wherein the first user interface element is a card element comprising an actionable item that, if selected by the first user, causes the first backend system to perform an action.

11. The non-transitory, computer-readable medium of claim 8, wherein implementing the first NLP model further comprises automatically performing an action at the first backend system based on a determination by the first NLP model.

12. The non-transitory, computer-readable medium of claim 11, wherein automatically performing an action at the first backend system comprises at least one of: ordering an item, authorizing an expenditure, and approving a request.

13. The non-transitory, computer-readable medium of claim 8, wherein training the first and send NLP models is performed at a management server remote from the first and second user devices.

14. The non-transitory, computer-readable medium of claim 8, wherein implementing the first NLP model further comprises reporting results of the first NLP model to a management server.

15. A system for implementing customized, on-device processing workflows, comprising:
a memory storage including a non-transitory, computer-readable medium comprising instructions; and
a computing device including a hardware-based processor that executes the instructions to carry out stages comprising:
training a first natural language processing (NLP) model using a first dataset relevant to a first backend system;
training a second NLP model using a second dataset relevant to a second backend system distinct from the first backend system;
assigning the first NLP model to a first organizational group comprising a first plurality of users;
assigning the second NLP model to a second organizational group comprising a second plurality of users;
based on determining that a first user device is assigned to a first user of the first plurality of users in the first organizational group:
providing the first NLP model to the first user device; and
instructing the first user device to implement the first NLP model with at least one application installed on the first user device, wherein implementing the first NLP model comprises:
detecting, at the first user device, a first trigger within text of the at least one application; and
displaying a first user interface element on the first user device based on the detected first trigger.

16. The system of claim 15, the stages further comprising, based on determining that a second user device is assigned to a second user of the second plurality of users in the second organizational group:
providing the second NLP model to the second user device; and
instructing the second user device to implement the second NLP model with at least one application installed on the second user device, wherein implementing the second NLP model comprises:
detecting a second trigger within text of the at least one application; and
displaying a second user interface element on the second user device based on the detected second trigger.

17. The system of claim 15, wherein the first user interface element is a card element comprising an actionable item that, if selected by the first user, causes the first backend system to perform an action.

18. The system of claim 15, wherein implementing the first NLP model further comprises automatically performing an action at the first backend system based on a determination by the first NLP model.

19. The system of claim 18, wherein automatically performing an action at the first backend system comprises at least one of: ordering an item, authorizing an expenditure, and approving a request.

20. The system of claim 15, wherein training the first and send NLP models is performed at a management server remote from the first and second user devices.
